(19) United States
(12) Patent Application Publication
(10) Pub. No.: US 2004/0172477 A1
(43) Pub. Date: Sep. 2, 2004

(54) Content providing system, content providing method, content providing program, and computer-readable recording medium

(76) Inventors: Dai Takeuchi, Tokyo (JP); Yasuhiko Iwai, Tokyo (JP); Osamu Hashimoto, Tokyo (JP)

Correspondence Address: OSHA & MAY L.L.P., 1221 MCKINNEY STREET, HOUSTON, TX, 77010, US

(21) Appl. No.: 10/485,443

(22) PCT Filed: Jul. 31, 2002
(86) PCT No.: PCT/JP02/07813

(30) Foreign Application Priority Data
Jul. 31, 2001 (JP) 2001-232196

(51) Int. Cl. G06F 15/16

(52) U.S. Cl. 709/232

(57) ABSTRACT

The present invention relates to a content providing system which can provide a user with a desirable content in a short time. This content providing system comprises content package receiving means for receiving a content package including a content and attribute information concerning an attribute of the content; content package extracting means for extracting a specific content package from received content packages; content package storing means including a specific area for storing the specific content package; content package alteration control means for erasing the content package stored in the specific area and so forth and inhibiting the user from erasing the detail of the content package and so forth according to an instruction signal; content package reading means for reading out the content package; and content providing means for providing the content included in the content package.

### TECHNICAL FIELD

The present invention relates to a content providing system, a content providing method, a content providing program, and a computer-readable recording medium.

### BACKGROUND ART

As information communication technologies have been evolving, content transmitting systems, which can provide users with contents such as moving image data, still image data, and music data remotely via the Internet have come into existence. By employing content providing systems such as personal computers, the users can receive information transmitted from content transmitting systems and utilize content thereof.

### DISCLOSURE OF THE INVENTION

Since conventional content transmitting systems and content providing systems provide users with contents via the Internet, their communication time becomes longer if contents such as high-quality moving image data, still image data, and music data are to be supplied, whereby the users may not be provided with the contents in a short time. Also, there are cases where contents sent to users must be managed on the content transmitting side after providing the contents. However, it is difficult for the conventional content transmitting systems and content providing systems to manage contents from the content transmitting side once the content is sent to the user side.

Therefore, it is an object of the present invention to provide a content providing system, a content providing method, a content providing program, and a computer-readable recording medium which can provide a user with a desirable content in a short time while making it easier to manage the content from the content transmitting side.

The present invention provides a content providing system comprising content package receiving means for receiving a content package, produced by a content transmitting system for transmitting a content to a user, including the content and attribute information concerning an attribute of the content from the content transmitting system; content package extracting means for extracting according to the attribute information a specific content package from content packages received by the content package receiving means; content package storing means including a specific area for storing the specific content package extracted by the content package extracting means; content package alteration control means for erasing or altering a detail of the content package stored in the specific area and inhibiting the user from erasing and altering the detail of the content package stored in the specific area according to an instruction signal transmitted from the content transmitting system; content package reading means for reading out the content package stored in the specific area; and content providing means for providing the user with the content included in the content package read out by the content package reading means.

In this aspect of the present invention, a content package received by the content package receiving means is stored in a specific area of the content package storing means, the content package reading means reads out the content package stored in the specific area, and the content providing means provides a user with the content included in thus read-out content package. Hence, if a content package corresponding to a request for providing a content is stored before a user makes the request, for example, the time required for providing the user with the content becomes shorter than in a case where the content is received and provided after the user requests that the content be provided. In response to an instruction signal from the content transmitting system, the content package alteration control means erases or alters the content package stored in the specific area, whereby the content package can be updated according to instructions from the content transmitting system. Also, since the content package alteration control means inhibits the user from erasing and altering the content package, the content package can be prevented from being updated in a manner not intended by the content transmitting side.

The present invention provides a content providing system comprising content requesting means for sending a content transmission request to a content transmitting system for producing a content package including a content and transmitting thus produced content package to a user; content package receiving means for receiving the content package transmitted by the content transmitting system in response to the transmission request sent by the content requesting means; content package storing means including a specific area for storing the content package received by the package receiving means; content package alteration control means for erasing or altering a detail of the content package stored in the specific area and inhibiting the user from erasing and altering the detail of the content package stored in the specific area according to an instruction signal transmitted from the content transmitting system; content package reading means for reading out the content package stored in the specific area; and content providing means for providing the user with the content included in the content package read out by the content package reading means.

In this aspect of the present invention, a content package transmitted by the content transmitting system in response to a content transmission request sent by the content requesting means is received by the content package receiving means, the content package received by the content package receiving means is stored in a specific area of the content package storing means, the content package reading means reads out the content package stored in the specific area, and the content providing means provides a user with the content included in thus read-out content package. Hence, if a content transmission request is automatically sent beforehand, and a content package corresponding to a request for providing a content is stored before a user makes the request, for example, the time required for providing the user with the content becomes shorter than in a case where the content is received and provided after the user requests that the content be provided. If a content transmission request is sent each time a user inputs the content transmission request, for example, the content package can be received and stored in each instance. In response to an instruction signal from the content transmitting system, the content package alteration control means erases or alters the content package stored in the specific area, whereby the content package can be updated according to instructions from the content transmitting system. Also, since the content package alteration control means inhibits the user from erasing and altering the content package, the content package can be prevented from being updated in a manner not intended by the content transmitting side.

The content providing system in accordance with the present invention may further comprise content package history transmitting means for transmitting history information of the content package read out by the content package reading means to the content transmitting system. Since the history information of the content package read out by the content package reading means is transmitted, the content transmitting system can grasp the history of the content supplied to the user.

The present invention provides a content providing method comprising the steps of causing content package receiving means to receive a content package, produced by a content transmitting system for transmitting a content to a user, including the content and attribute information concerning an attribute of the content from the content transmitting system; causing content package extracting means to extract according to the attribute information a specific content package from content packages received by the content package receiving means and store thus extracted specific content package into a specific area of content package storing means; causing content package alteration control means to erase or alter a detail of the content package stored in the specific area and inhibit the user from erasing and altering the detail of the content package stored in the specific area according to an instruction signal transmitted from the content transmitting system; causing content package reading means to readout the content package stored in the specific area; and causing content providing means to provide the user with the content included in the content package read out by the content package reading means.

In this aspect of the present invention, a content package received by the content package receiving means is stored in a specific area of the content package storing means, the content package reading means reads out the content package stored in the specific area, and the content providing means provides a user with the content included in thus read-out content package. Hence, if a content package corresponding to a request for providing a content is stored before a user makes the request, for example, the time required for providing the user with the content becomes shorter than in a case where the content is received and provided after the user requests that the content be provided. In response to an instruction signal from the content transmitting system, the content package alteration control means erases or alters the content package stored in the specific area, whereby the content package can be updated according to instructions from the content transmitting system. Also, since the content package alteration control means inhibits the user from erasing and altering the content package, the content package can be prevented from being updated in a manner not intended by the content transmitting side.

The present invention provides a content providing method comprising the steps of causing content requesting means to send a content transmission request to a content transmitting system for producing a content package including a content and transmitting thus produced content package to a user; causing content package receiving means to receive the content package transmitted by the content transmitting system in response to the transmission request sent by the content requesting means and store thus received content package into a specific area of content package storing means; causing content package alteration control means to erase or alter a detail of the content package stored in the specific area and inhibit the user from erasing and altering the detail of the content package stored in the specific area according to an instruction signal transmitted from the content transmitting system; causing content package reading means to read out the content package stored in the specific area; and causing content providing means to provide the user with the content included in the content package read out by the content package reading means.

In this aspect of the present invention, a content package transmitted by the content transmitting system in response to a content transmission request sent by the content requesting means is received by the content package receiving means, the content package received by the content package receiving means is stored in a specific area of the content package storing means, the content package reading means reads out the content package stored in the specific area, and the content providing means provides a user with the content included in thus read-out content package. Hence, if a content transmission request is automatically sent beforehand, and a content package corresponding to a request for providing a content is stored before a user makes the request, for example, the time required for providing the user with the content becomes shorter than in a case where the content is received and provided after the user requests that the content be provided. If a content transmission request is sent each time a user inputs the content transmission request, for example, the content package can be received and stored in each instance. In response to an instruction signal from the content transmitting system, the content package alteration control means erases or alters the content package stored in the specific area, whereby the content package can be updated according to instructions from the content transmitting system. Also, since the content package alteration control means inhibits the user from erasing and altering the content package, the content package can be prevented from being updated in a manner not intended by the content transmitting side.

The content providing method in accordance with the present invention may further comprise the step of causing content package history transmitting means to transmit history information of the content package read out by the content package reading means to the content transmitting system. Since the history information of the content package read out by the content package reading means is transmitted, the content transmitting system can grasp the history of the content supplied to the user.

The present invention provides a content providing program for causing a computer to function as content package receiving means for receiving a content package, produced by a content transmitting system for transmitting a content to a user, including the content and attribute information concerning an attribute of the content from the content transmitting system; content package extracting means for extracting according to the attribute information a specific content package from content packages received by the content package receiving means and storing thus extracted specific content package into a specific area of content package storing means; content package alteration control means for erasing or altering a detail of the content package stored in the specific area and inhibiting the user from erasing and altering the detail of the content package stored in the specific area according to an instruction signal transmitted from the content transmitting system; content package reading means for reading out the content package stored in the specific area; and content providing means for providing the user with the content included in the content package read out by the content package reading means.

When the content providing program in accordance with this aspect of the present invention is executed by using a computer, a content package received by the content package receiving means is stored in a specific area of the content package storing means, the content package reading means reads out the content package stored in the specific area, and the content providing means provides a user with the content included in thus read-out content package. Hence, for example, the time required for providing the user with the content becomes shorter than in a case where the content is received and provided after the user requests that the content be provided. In response to an instruction signal from the content transmitting system, the content package alteration control means erases or alters the content package stored in the specific area, whereby the content package can be updated according to instructions from the content transmitting system. Also, since the content package alteration control means inhibits the user from erasing and altering the content package, the content package can be prevented from being updated in a manner not intended by the content transmitting side.

The present invention provides a content providing program for causing a computer to function as content requesting means for sending a content transmission request to a content transmitting system for producing a content package including a content and transmitting thus produced content package to a user; content package receiving means for receiving the content package transmitted by the content transmitting system in response to the transmission request sent by the content requesting means and storing thus received content package into a specific area of content package storing means; content package alteration control means for erasing or altering a detail of the content package stored in the specific area and inhibiting the user from erasing and altering the detail of the content package stored in the specific area according to an instruction signal transmitted from the content transmitting system; content package reading means for reading out the content package stored in the specific area; and content providing means for providing the user with the content included in the content package read out by the content package reading means.

When the content providing program in accordance with this aspect of the present invention is executed by using a computer, a content package transmitted by the content transmitting system in response to a content transmission request sent by the content requesting means is received by the content package receiving means, the content package received by the content package receiving means is stored in a specific area of the content package storing means, the content package reading means reads out the content package stored in the specific area, and the content providing means provides a user with the content included in thus read-out content package. Hence, if a content transmission request is automatically sent beforehand, and a content package corresponding to a request for providing a content is stored before a user makes the request, for example, the time required for providing the user with the content becomes shorter than in a case where the content is received and provided after the user requests that the content be provided. If a content transmission request is sent each time a user inputs the content transmission request, for example, the content package can be received and stored in each instance. In response to an instruction signal from the content transmitting system, the content package alteration control means erases or alters the content package stored in the specific area, whereby the content package can be updated according to instructions from the content transmitting system. Also, since the content package alteration control means inhibits the user from erasing and altering the content package, the content package can be prevented from being updated in a manner not intended by the content transmitting side.

The content providing program in accordance with the present invention may further cause the computer to function as content package history transmitting means for transmitting history information of the content package read out by the content package reading means to the content transmitting system. Since the history information of the content package read out by the content package reading means is transmitted, the content transmitting system can grasp the history of the content supplied to the user.

The present invention provides a computer-readable recording medium recording therein any of the above-mentioned content providing programs.

When the content providing program recorded in the recording medium in accordance with this aspect of the present invention is executed by using a computer, a content package received by the content package receiving means is stored in a specific area of the content package storing means, the content package reading means reads out the content package stored in the specific area, and the content providing means provides a user with the content included in thus read-out content package. Hence, for example, the time required for providing the user with the content becomes shorter than in a case where the content is received and provided after the user requests that the content be provided. In response to an instruction signal from the content transmitting system, the content package alteration control means erases or alters the content package stored in the specific area, whereby the content package can be updated according to instructions from the content transmitting system. Also, since the content package alteration control means inhibits the user from erasing and altering the content package, the content package can be prevented from being updated in a manner not intended by the content transmitting side.

### BRIEF DESCRIPTION OF THE DRAWINGS

FIG. 1 is a diagram showing the configuration of the content providing system in accordance with an embodiment;

FIG. 2 is a diagram showing information included in a content package handled by the content providing system of FIG. 1;

FIG. 3 is a diagram showing a storage area of a content package storing section in FIG. 1;

FIG. 4 is a flowchart showing operations of the content providing system of FIG. 1;

FIG. 5 is a flowchart showing operations of the content providing system of FIG. 1;

FIG. 6 is a flowchart showing operations of the content providing system of FIG. 1;

FIG. 7 is a diagram showing the configuration of a recording medium recording therein the content providing program in accordance with an embodiment;

FIG. 8 is a diagram showing the configuration of the content providing system in accordance with an embodiment;

FIG. 9 is a flowchart showing operations of the content providing system of FIG. 8;

FIG. 10 is a diagram showing the configuration of the recording medium recording therein the content providing program in accordance with an embodiment;

FIG. 11 is a system diagram of a computer; and

FIG. 12 is a perspective view of the computer.

### BEST MODES FOR CARRYING OUT THE INVENTION

Embodiments of the present invention will be explained with reference to the drawings. When possible, parts identical to each other will be referred to with numerals identical to each other without repeating their overlapping descriptions. While data flows may be illustrated schematically in the embodiments, protocols such as TCP/IP can be used for data communications in system configurations in practice. As a higher level protocol of TCP/IP, http (Hyper Text Transfer Protocol) used in WWW (World Wide Web) can be employed. On these protocols, HTML (Hyper Text Markup Language) defining display formats of WWW browsers can be used. Employable protocols and description languages are not restricted to those mentioned above. Any other higher level protocols and description languages can be used within a range in which the object of the present invention can be achieved.

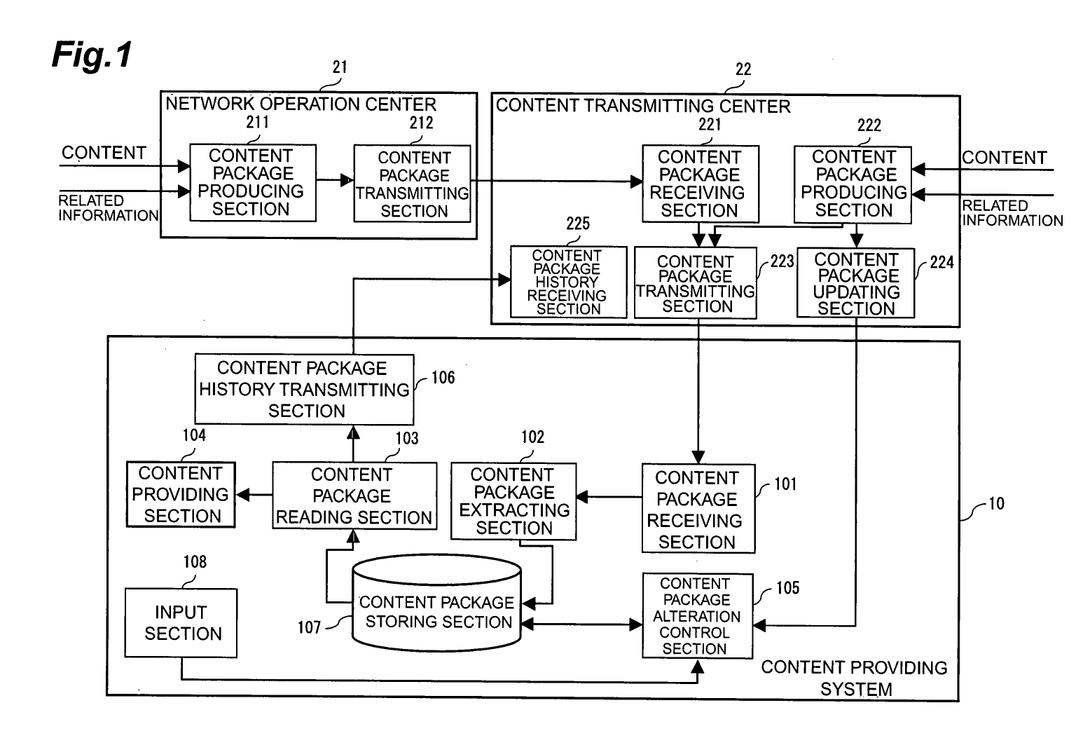

A content providing system 10 in accordance with a first embodiment of the present invention will be explained with reference to FIG. 1. FIG. 1 is a diagram showing the configuration of the content providing system 10. The content providing system 10 provides users with contents. Here, contents refer to a set of data typified by moving image data, still image data, and music data. The content providing system 10 is connected to a content transmitting center (content transmitting system) 22 via a communication line (not depicted), and can send/receive information thereto/therefrom. The content transmitting center 22 is also connected to a network operation center 21.

First, the network operation center 21 will be explained. The network operation center 21 is a center for managing the content transmitting center 22, and is physically constructed as equipment comprising a data processing computer and a communication device. The network operation center 21 comprises, as functional constituents, a content package producing section 211 and a content package transmitting section 212. In the following, the individual constituents will be explained.

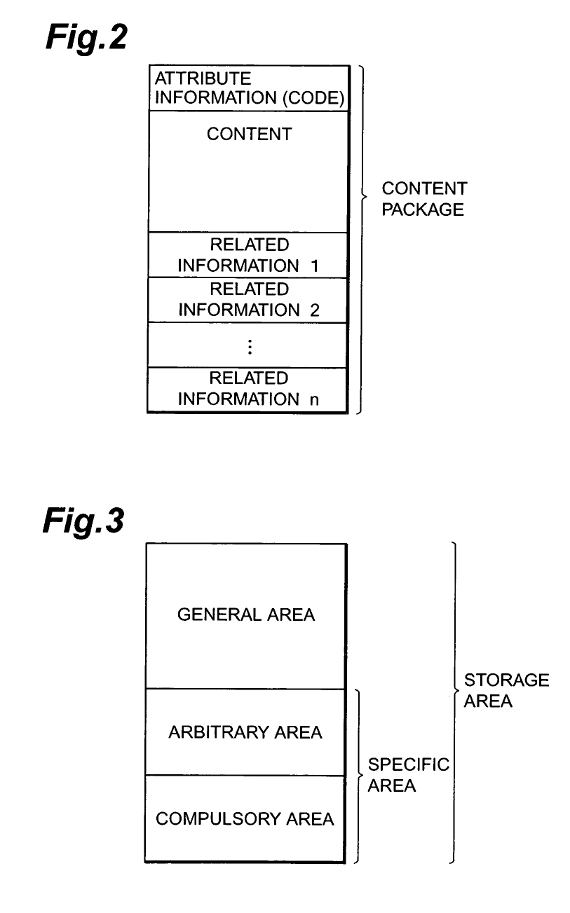

The content package producing section 211 is a part producing a content package including a content and attribute information concerning an attribute of the content. More specifically, the content package producing section 211 takes therein a content and information related to the content supplied from a content provider, and produces attribute information of the content. Also, the content package producing section 211 produces a content package which is a set of data including the content and related information taken therein and the produced attribute information. Here, the related information is information related to the content. If the content is sample music data for promoting the sale of a compact disc, the related information corresponds to information concerning transitions in the amount of sale of the compact disc, information concerning the price of the compact disc, information concerning artists, and the like. The attribute information is information concerning an attribute of the content, and includes species information concerning the species of the content in particular. The species information includes information concerning data formats, e.g., whether the content is moving image data, still image data, or music data, fields, e.g., whether the content relates to sports or travel and whether the content relates to soccer or baseball in particular among the sports, and the like. The attribute information in some of content packages includes information for a content package extracting section 102 of the content providing system 10 to extract content packages compulsorily (details of which will be explained later). Here, it will be preferred if the attribute information is encoded. Coding the attribute information makes it easier to extract and retrieve content packages, and so forth. Information included in a content package can be illustrated as shown in FIG. 2. A content package is produced for each content. One content package may include not only one item of related information, but a plurality of items of related information. The content package producing section 211 outputs the produced content package to the content package transmitting section 212.

Returning to FIG. 1, the content package transmitting section 212 transmits to a content package receiving section 221 of the content transmitting center 22 the content package outputted from the content package producing section 211.

The content transmitting center 22 is a center for transmitting content packages to users, and is physically constructed as equipment comprising a transmission device. Here, the content transmitting center 22 is one transmitting content packages via a communication network or broadcasting network. Examples using communication networks include CATV (Community Antenna Television), DSL (Digital Subscriber Line), and FTTH (Fiber To The Home). Examples using broadcasting networks include satellite broadcasts using satellites, and terrestrial broadcasts by way of ground relay stations. Closed networks may also be used. Content packages may be transmitted over a plurality of networks as in the Internet. The content transmitting center 22 comprises, as functional constituents, the content package receiving section 221, a content package producing section 222, a content package transmitting section 223, a content package updating section 224, and a content package history receiving section 225. In the following, the individual constituents will be explained.

The content package receiving section 221 of the content transmitting center 22 receives content packages transmitted from the content package transmitting section 212 of the network operation center 21. Also, the content package receiving section 221 outputs the received content packages to the content package transmitting section 223.

As with the content package producing section 211 of the network operation center 21, the content package producing section 222 of the content transmitting center 22 is a part producing a content package including a content and attribute information concerning an attribute of the content. More specifically, the content package producing section 222 takes therein a content and information related to the content supplied from a content provider, and produces attribute information of the content. Also, the content package producing section 222 produces a content package which is a set of data including the content and related information taken therein and the produced attribute information. The content package producing section 22 also outputs thus generated content package to the content package transmitting section 223 and the content package updating section 224. Here, not only the network operation center 21 but also the content transmitting center 22 is provided with the content package producing section 222, whereby the content transmitting center 22 can produce original content packages and provide users with thus produced content packages. Namely, a plurality of content transmitting centers 22 placed in respective regions can originally provide users with contents including local information items closely related to their respective regions, if each content transmitting center 22 is provided with its own content package producing section 222.

The content package transmitting section 223 is a part transmitting content packages produced by the content package producing section 211 of the network operation center 21 and content packages produced by the content package producing section 222 of the content transmitting center 22 to the content providing system 10 employed by the user.

The content package updating section 224 is a part transmitting a content package outputted by the content package producing section 222, together with an instruction signal for ordering an older content package to be updated to thus outputted content package, to the content providing system 10 employed by a user. The content package updating section 224 is a part transmitting to the content providing system 10 an instruction signal for instructing the content providing system 10 to erase a content package stored therein.

The content package history receiving section 225 is a part receiving from the content providing system employed by the user a history of content packages read out by the user. The network operation center 21 may further comprise the content package updating section 224 and content package history receiving section 225.

In the following, the content providing system 10 will be explained. The content providing system 10 is physically constructed as a computer system (e.g., workstation or personal computer) comprising a CPU (central processing unit), a memory, input devices such as mouse and keyboard, a display device such as display, and storage devices such as hard disk.

The content providing system 10 comprises, as functional constituents, a content package receiving section (content package receiving means) 101, a content package extracting section (content package extracting means) 102, a content package reading section (content package reading means) 103, a content providing section (content providing means) 104, a content package alteration control section (content package alteration control means) 105, a content package history transmitting section (content package history transmitting means) 106, a content package storing section (content package storing means) 107, and an input section 108. In the following, the individual constituents will be explained in detail.

The content package receiving section 101 of the content providing section 10 is a part receiving content packages transmitted from the content package transmitting section 223 of the content transmitting center 22. Also, the content package receiving section 101 outputs thus received content packages to the content package extracting section 102.

The content package extracting section 102 is a part extracting, from the content packages received by the content package receiving section 101, a specific content package according to attribute information. More specifically, the content package extracting section 102 extracts, according to species information included in the attribute information, a specific kind of content package conforming to a condition determined by the user beforehand. For example, when the user has determined beforehand a condition for extracting a content package concerning a new disc of a Japanese rock singer, the content package extracting section 102 extracts the content package concerning the new disc of the Japanese rock singer by referring to the species information included in the attribute information. Also, the content package extracting section 102 compulsorily extracts a content package including information to be compulsorily extracted in its attribute information. When a predetermined content package is compulsorily extracted as such, a content package including a content concerning an advertisement by a sponsor company, for example, can compulsorily be extracted regardless of conditions determined by users.

The content package storing section 107 is a part storing the specific content package extracted by the content package extracting section 102. Here, as shown in FIG. 3, the storage area of the content package storing section 107 is divided into a general area and a specific area. The extracted specific content package is stored into the specific area. The user can browse the information stored in the specific area, but cannot erase nor alter details of the information. As will be explained later, details of the information can be erased and altered according to an instruction signal from the content transmitting center 22. The general area is an area in which the user can freely erase, alter, and browse information. This is an area in which, for example, data of application software such as word processing software and spreadsheet software are stored. Though the physically integral storage area is partitioned into the general area and the specific area in this embodiment, the general area and the specific area may be formed as storing sections physically separated from each other. Also, the whole storage area of the content package storing section 107 may be employed as the specific area.

As shown in FIG. 3, the specific area of the content package storing section 107 is further divided into an arbitrary area and a compulsory area. The arbitrarily area is an area storing, among the content packages extracted by the content package extracting section 102, a specific kind of content package conforming to a condition determined beforehand by the user. For example, if the user has determined beforehand a condition for extracting a content package concerning a new disc of a Japanese rock singer, the content package concerning the new disc of the Japanese rock singer is stored in the arbitrary area. On the other hand, the compulsory area is an area storing, among the content packages extracted by the content package extracting section 102, the compulsorily extracted content package. Namely, the compulsory area stores such a content package that information for compulsory extraction (e.g., an address in a compulsory area) is included in the attribute information. When the content package storing section 107 is provided with a compulsory area for compulsorily storing a specific content package, for example, a content package including a content concerning an advertisement by a sponsor company can compulsorily be stored in the content package storing section 107 regardless of conditions determined by users. Namely, when the content package storing section 107 is provided with a compulsory area for compulsorily storing a specific content package, a predetermined area within the compulsory area can be assigned to a specific company such as a sponsor while specifying the volume for use, term of use, and the like. This makes it possible to collect usage charges for the storage area from the specific company such as a sponsor to which the predetermined area is assigned.

The content package reading section 103 reads out the content package stored in the content package storing section 107. Here, the content package reading section 103 also functions to retrieve the content package according to the attribute information. Further, the content package reading section 103 extracts the content from the read-out content package, and outputs the content to the content providing section 104. To the content package history transmitting section 106, the content package reading section 103 outputs history information about the extraction of contents from content packages. The history information includes information about when and what contents were extracted, etc.

The content package history transmitting section 106 is a part transmitting to the content package history receiving section 225 of the content transmitting center 22 the history information outputted from the content package reading section 103. Since the content package history transmitting section 106 transmits to the content package history receiving section 225 of the content transmitting center 22 the history information in which the content package reading section 103 extracts contents from content packages, the content transmitting center 22 can acquire information about which contents the user browses, etc. The content package history transmitting section 106 may transmit the history information collectively at predetermined intervals or individually each time the reading section 103 outputs a history information item.

The content providing section 104 is a part providing the user with the content included in the content package read out by the content package reading section 103. More specifically, when the content includes moving image data, the content providing section 104 causes a display to show the moving image. When the content includes music data, the content providing section 104 reproduces the music through speakers or headphones. Here, while providing the content, the content providing section 104 causes the display to show an icon or the like for reading out the content package compulsorily stored in the compulsory area of the content package storing section 107 after being compulsorily extracted by the content package extracting section 102. When this icon is clicked, the content package reading section 103 reads out from the content package storing section 107 the compulsorily extracted and stored content package, whereas the content providing section 104 provides the user with the content included in the content package. When an icon or the like for reading out the compulsorily extracted and stored content package is shown on the display so that the user is provided with the content package upon clicking the icon as such, the user can be provided with the content concerning an advertisement by a sponsor company, for example, in a relatively easy manner. Without being restricted to the mode mentioned above, the compulsorily extracted and stored content package may be provided in succession to the content stored in the arbitrary area, or automatically provided beside a screen supplying the content stored in the arbitrary area or the like.

The content package alteration control section 105 is a part erasing or altering details of the content package stored in the specific area of the content package storing section 107 in response to an instruction signal transmitted from the content package updating section 224 of the content transmitting center 22. The content package alteration control section 105 is also a part inhibiting the user from erasing or altering details of the content package stored in the specific area. More specifically, assuming that three kinds of content packages of video clips concerning a soccer player are stored in the content package storing section 107 and that one of them is to be deleted after three days in connection with the contract between the player and a sponsor, the content package alteration control section 105 deletes the content package in response to an instruction signal from the content package updating section 224 of the content transmitting center 22. When the user inputs an order to alter the information stored in the storage area of the content package storing section 107 from the input section 108 of the content providing system 10, on the other hand, the content package alteration control section 105 does not accept the order to alter the information in the specific area but the order to alter the information stored in the general area.

The input section 108 is a part receiving the input of information from the user, and employs an interface such as a keyboard and mouse. The information inputted from the input section 108 is outputted to the content package alteration control section 105 and the content package reading section 103.

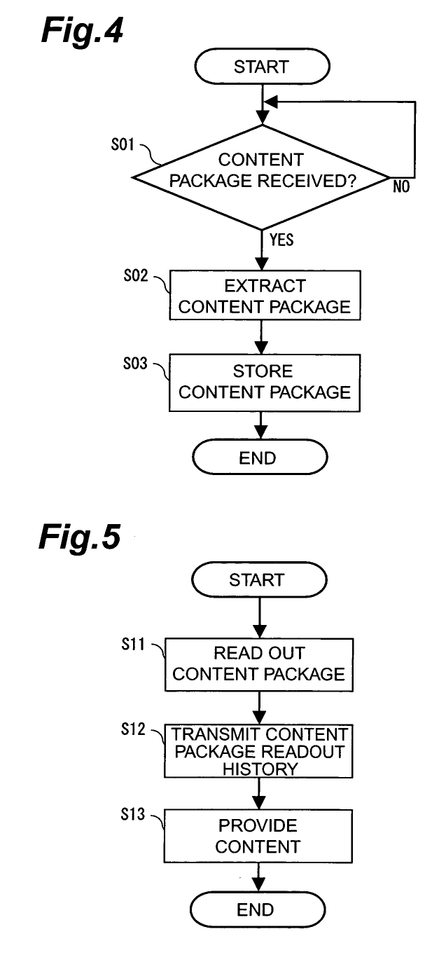

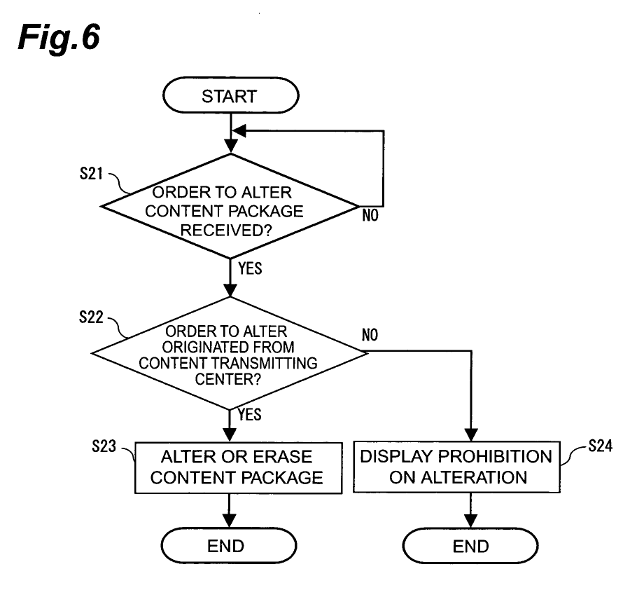

With reference to FIGS. 4 to 6, a method of providing a user with a content by using the content providing system 10 in accordance with this embodiment will now be explained. FIG. 4 is a flowchart showing operations of storing a content package into the content providing system 10. FIG. 5 is a flowchart showing operations in which the content providing system 10 supplies the content. FIG. 6 is a flowchart showing operations of altering the content package stored in the content providing system 10 and so forth.

With reference to FIG. 4, operations of storing a content package into the content providing system 10 will be explained. The content package receiving section 101 of the content providing system 10 is in a wait state for receiving a content package from the content package transmitting section 223 of the content transmitting center 22 (step S01). Upon receiving the content package from the content package transmitting section 223, the content package receiving section 101 outputs thus received content package to the content package extracting section 102.

Upon receiving the content package from the content package receiving section 101, the content package extracting section 102 extracts a specific content package according to attribute information (step S02). Specifically, according to species information included in the attribute information of the content package, the content package extracting section 102 extracts a specific kind of content package conforming to a condition determined by the user beforehand.

The content package extracted by the content package extracting section 102 is stored into the content package storing section 107 (step S03). Here, as shown in FIG. 3, the storage area of the content package storing section 107 is divided into a general area and a specific area, whereas the specific area is further divided into an arbitrary area and a compulsory area. Among the content packages extracted by the content package extracting section 102, the specific kind of content package conforming to the condition determined by the user beforehand is stored into the arbitrary area whereas the compulsorily extracted content package is stored into the compulsory area.

With reference to FIG. 5, operations in which the content providing system 10 supplies a content will now be explained. When the user requests that a content be provided, the content package reading section 103 reads out the content package stored in the content package storing section 107 (step S11). Upon reading out the content package, the content package reading section 103 extracts the content from thus read-out content package, and outputs the content to the content providing section 104. To the content package history transmitting section 106, the content package reading section 103 outputs history information in which the content is extracted from the content package.

To the content package history receiving section 225 of the content transmitting center 22, the content package history transmitting section 106 transmits the history information outputted from the content package reading section 103 (step S12). The content package history transmitting section 106 may transmit the history information collectively at predetermined intervals or individually each time the content package reading section 103 outputs a history information item.

The content providing section 104 provides the user with the content included in the content package read out by the content package reading section 103 (step S13). More specifically, when the content includes moving image data, the content providing section 104 causes a display to show the moving image. When the content includes music data, the content providing section 104 reproduces the music through speakers or headphones. Here, while providing the content, the content providing section 104 causes the display to show an icon or the like for reading out the content package compulsorily stored in the compulsory area of the content package storing section 107 after being compulsorily extracted by the content package extracting section 102. When this icon is clicked, the content package reading section 103 reads out from the content package storing section 107 the compulsorily extracted and stored content package, whereas the content providing section 104 provides the user with the content included in the content package.

With reference to FIG. 6, operations of altering the content package stored in the content providing system 10 and so forth will now be explained. The content package alteration control section 105 of the content providing system 10 is in a wait state for receiving an instruction signal for altering the content package stored in the content package storing section 107 from the content package updating section 224 of the content transmitting center 22 (step S21). In an example of details of alteration instructed by the instruction signal, assuming that three kinds of content packages of video clips concerning a soccer player are stored in the content package storing section 107 and that one of them is to be deleted after three days in connection with the contract between the player and a sponsor, the content package is ordered to be deleted after the three days.

Upon receiving the instruction signal, the content package alteration control section 105 verifies if thus instructed signal is from the content package updating section 224 of the content transmitting center 22 or not (step S22). The user is only permitted to browse the content package stored in the specific area of the content package storing section 107. For example, even when the user inputs an order to alter the content package stored in the specific area of the content package storing section 107 from the input section 108, the content package alteration control section 105 does not alter particulars of the specific area in the content package storing section 107.

When the instruction signal originates from the content package updating section 224 of the content transmitting center 22, the content package alteration control section 105 alters or erases the content package stored in the specific area of the content package storing section 107 according to the instruction signal (step S23). When the instruction signal does not originate from the content package updating section 224, on the other hand, the content package alteration control section 105 does not alter the content package stored in the specific area of the content package storing section 107 and so forth, but displays prohibition on alteration and the like, so as to notify that the content package cannot be altered (step S24).

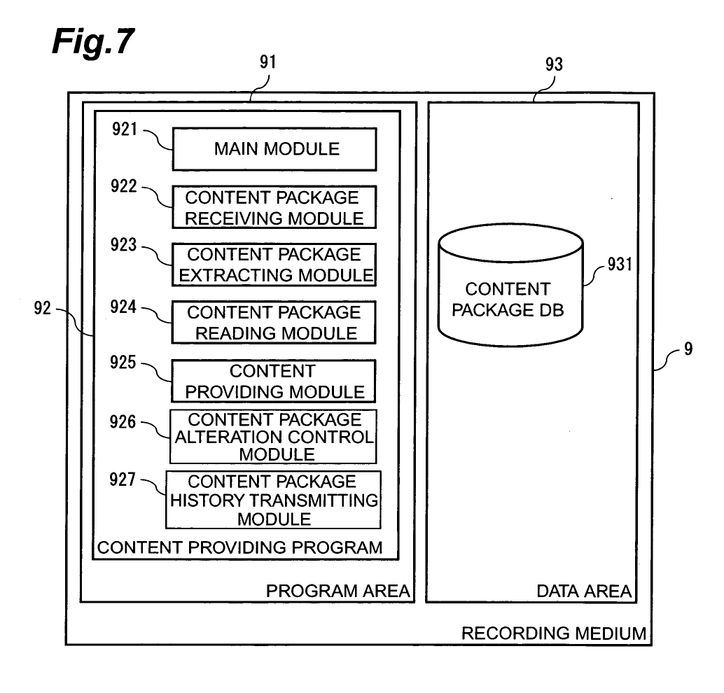

In the following, a content providing program 92 for causing a computer to function as the content providing system 10, which is an embodiment of the present invention, and a computer-readable recording medium 9 recording therein this program will be explained. FIG. 7 is a diagram showing the configuration of the recording medium 9 recording therein this program. Examples of the recording medium 9 include magnetic disks, optical disks, CD-ROM, and memories incorporated in computers.

As shown in FIG. 7, the recording medium 9 comprises a program area 91 for recording programs, and a data area 93 for recording data. A content package database 931 similar to the content package storing section 107 explained with reference to FIGS. 1 and 3 is stored in the data area 93.

The content providing program 92 is recorded in the program area 91. The content providing program 92 comprises a main module 921 for controlling the processing as a whole, a content package receiving module 922, a content package extracting module 923, a content package reading module 924, a content providing module 925, a content package alteration control module 926, and a content package history transmitting module 927. Here, respective functions realized by operating the content package receiving module 922, content package extracting module 923, content package reading module 924, content providing module 925, content package alteration control module 926, and content package history transmitting module 927 are the same as those of the content package receiving section 101, content package extracting section 102, content package reading section 103, content providing section 104, content package alteration control section 105, and content package history transmitting section 106 in the content providing system 10.

Operations and effects of this embodiment will now be explained. The content package received by the content package receiving section 101 is stored into the specific area of the content package storing section 107, the content package reading section 103 reads out the content package stored in the specific area, and the content providing section 104 provides the user with the content included in thus read-out content package. Hence, if a content package corresponding to a request for providing a content is stored before a user makes the request, for example, the time required for providing the user with the content becomes shorter than in a case where the content is received and provided after the user requests that the content be provided. In response to an instruction signal from the content transmitting center 22, the content package alteration control section 105 erases or alters the content package stored in the specific area, whereby the content package can be updated according to instructions from the content transmitting center 22. Also, since the content package alteration control section 105 inhibits the user from erasing and altering the content package, the content package can be prevented from being updated in a manner not intended by the content transmitting side.

Since the content package history transmitting section 106 transmits history information of the content package read out by the content package reading section 103, the content transmitting center 22 can grasp the history of the content supplied to the user.

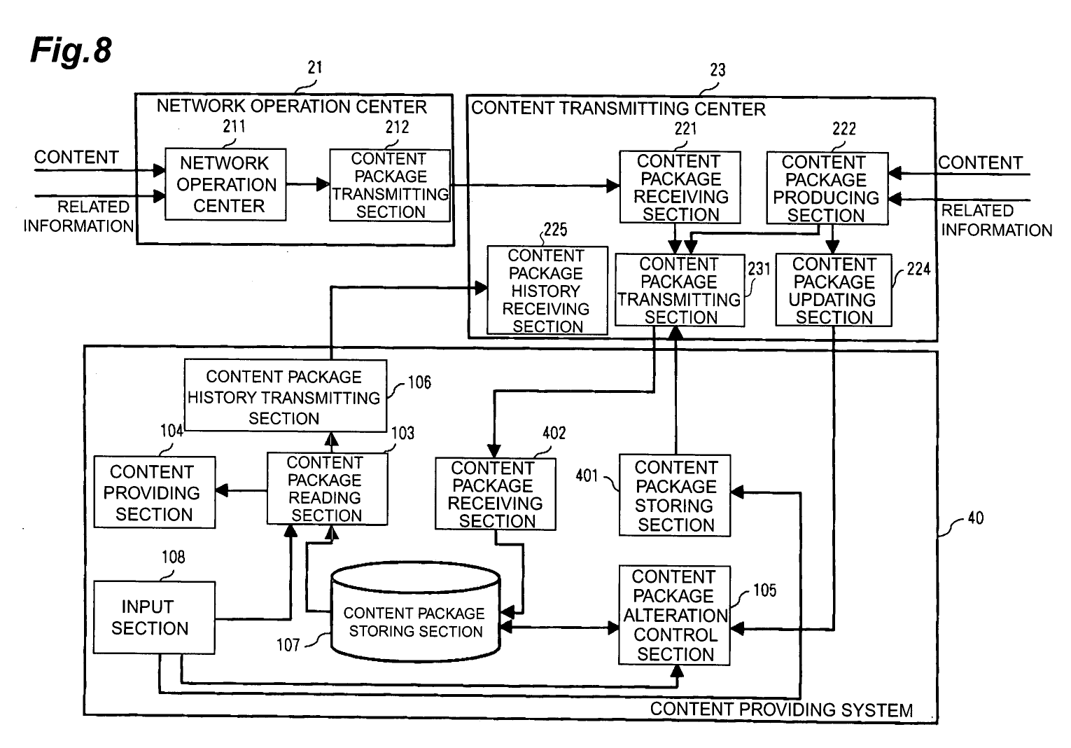

A content providing system 40, which is a second embodiment of the present invention, will be explained with reference to FIG. 8. FIG. 8 is a diagram showing the configuration of the content providing system 40. The content providing system 40 is connected to a content transmitting center (content transmitting system) 23 via a communication line (not depicted), and can send/receive information thereto/therefrom. The content transmitting center 23 is also connected to a network operation center 21. The network operation center 21 is the same as that in the first embodiment, and thus will not be explained.

The content transmitting center 23 is a center for transmitting content packages to users, and is physically constructed as equipment comprising a transmission device. The content transmitting center 23 comprises, as functional constituents, a content package receiving section 221, a content package producing section 222, a content package transmitting section 231, a content package updating section 224, and a content package history receiving section 225. In the following, the individual constituents will be explained. However, since the constituents other than the content package transmitting section 231 are the same as those in the first embodiment, only the content package transmitting section 231 will be explained.

The content package transmitting section 231 is a part transmitting content packages produced by the content package producing section 211 of the network operation center 21 and content packages produced by the content package producing section 222 of the content transmitting center 23 to the content providing system 10 employed by the user. The content package transmitting section 231 receives a content transmission request from the user and transmits the content package conforming to the content transmission request.

In the following, the content providing system 40 will be explained. The content providing system 40 is physically constructed as a computer system (e.g., workstation or personal computer) comprising a CPU (central processing unit), a memory, input devices such as mouse and keyboard, a display device such as display, and storage devices such as hard disk.

The content providing system 40 comprises, as functional constituents, a content requesting section (content requesting means) 401, a content package receiving section (content package receiving means) 402, a content package reading section (content package reading means) 103, a content providing section (content providing means) 104, a content package alteration control section (content package alteration control means) 105, a content package history transmitting section (content package history transmitting means) 106, a content package storing section (content package storing means) 107, and an input section 108. In the following, the individual constituents will be explained in detail. However, the constituents other than the content requiring section 401 and content package receiving section 402 are the same as those in the first embodiment and thus will not be explained.

The content requesting section 401 of the content providing system 40 is a part sending to the content transmitting section 23 a transmission request inputted by the user from the input section 108 to request that a content be transmitted. Specifically, if the user sets an item called “soccer”, a transmission request demanding that a content concerning soccer be transmitted is sent to the content package transmitting section 231 of the content transmitting center 23. The content requesting section 401 may send each transmission request as inputted by the user from the input section 108 or automatically send transmission requests at predetermined intervals or according to a predetermined condition.

The content package receiving section 402 of the content providing system 40 is a part receiving the content package transmitted by the content package transmitting section 231 of the content transmitting center 23, and stores thus received content package into the content package storing section 107.

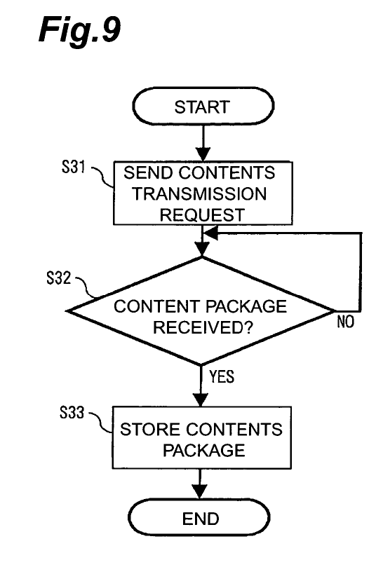

With reference to FIG. 9, a method of providing a user with a content will now be explained. FIG. 9 is a flowchart showing operations of storing a content package into the content providing system 40. Operations of supplying a content, changing a content package, and so forth after storing the content package into the content providing system 40 are the same as those in the first embodiment and thus will not be explained.

With reference to FIG. 9, operations of storing a content package into the content providing system 40 will be explained. According to information inputted from the input section 108, the content requiring section 401 of the content providing system 40 sends a content transmission request to the content package transmitting section 231 of the content transmitting center 23 (step S31). Upon sending the content transmission request, the content package receiving section 402 of the content providing system 40 is placed in a wait state for receiving a content package from the content package transmitting section 231 of the content transmitting center 23 (step S32). Upon receiving the content package from the content package transmitting section 231, the content package receiving section 402 stores thus received content package into the content package storing section 107 (step S33).

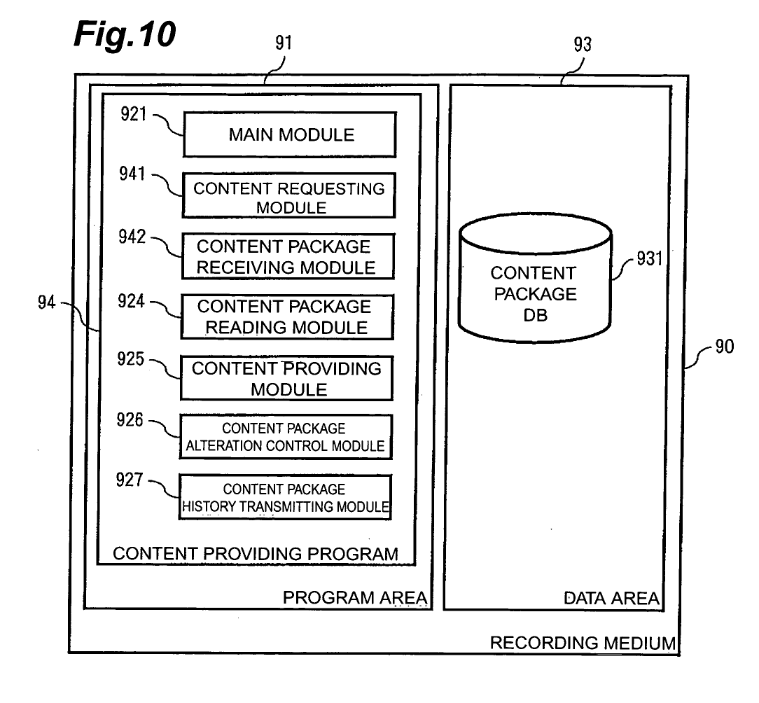

In the following, a content providing program 94 for causing a computer to function as the content providing system 40, which is an embodiment of the present invention, and a computer-readable recording medium 90 recording therein this program will be explained. FIG. 10 is a diagram showing the configuration of the recording medium 90 recording therein this program. Examples of the recording medium 90 include magnetic disks, optical disks, CD-ROM, and memories incorporated in computers.

As shown in FIG. 10, the recording medium 90 comprises a program area 91 for recording programs, and a data area 93 for recording data. A content package database 931 similar to the content package storing section 107 in the first embodiment is stored in the data area 93.

The content providing program 94 is recorded in the program area 91. The content providing program 94 comprises a main module 921 for controlling the processing as a whole, a content requesting module 941, a content package receiving module 942, a content package reading module 924, a content providing module 925, a content package alteration control module 926, and a content package history transmitting module 927. Here, the modules other than the content requesting module 941 and content package receiving module 942 are the same as those in the first embodiment and thus will not be explained. Respective functions realized by operating the content requesting module 941 and content package receiving module 942 are the same as those of the content requesting section 401 and content package receiving section 401 in the content providing system 40.

Operations and effects of this embodiment will be explained. The content package receiving section 402 receives the content package transmitted by the content transmitting center 23 in response to the content transmission request sent by the content requesting section 401, the content package received by the content package receiving section 402 is stored into the specific area of the content package storing section 107, the content package reading section 103 reads out the content package stored in the specific area, and the content providing section 104 provides the user with the content included in thus read-out content package. Hence, if a content transmission request is automatically sent beforehand, and a content package corresponding to a request for providing a content is stored before a user makes the request, for example, the time required for providing the user with the content becomes shorter than in a case where the content is received and provided after the user requests that the content be provided. If a content transmission request is sent each time the user inputs the content transmission request, for example, the content package can be received and stored in each instance. In response to an instruction signal from the content transmitting center 22, the content package alteration control section 105 erases or alters the content package stored in the specific area, whereby the content package can be updated according to instructions from the content transmitting center 22. Also, since the content package alteration control section 105 inhibits the user from erasing and altering the content package, the content package can be prevented from being updated in a manner not intended by the content transmitting side.

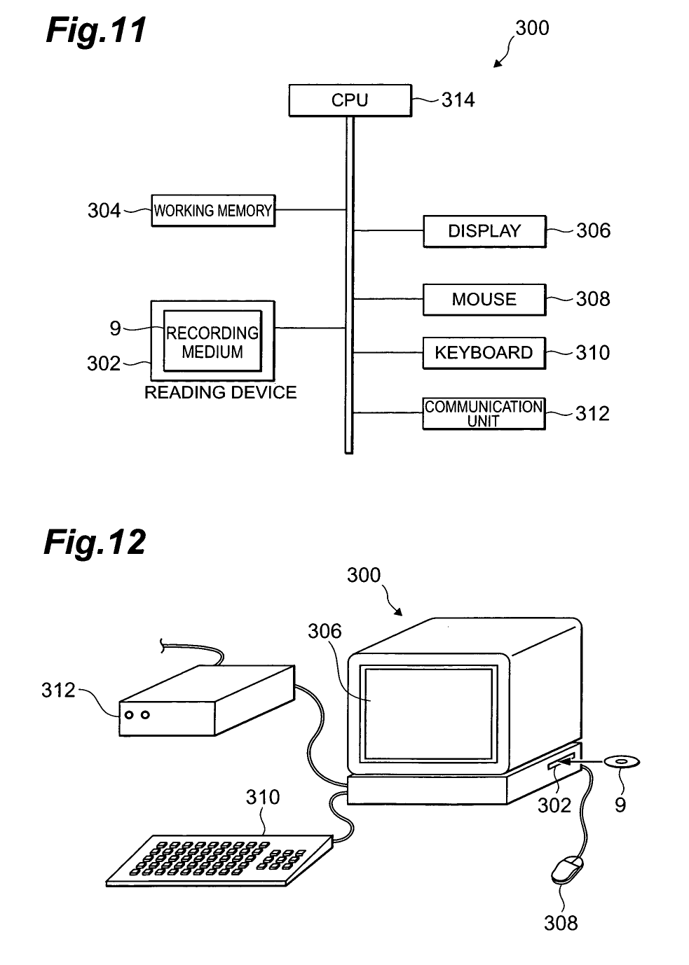

FIG. 11 is a system diagram of a computer (e.g., server system) for executing the program recorded in the recording medium 9, whereas FIG. 12 is a perspective view of the computer for executing the content providing program 92 recorded in the recording medium 9. As shown in FIGS. 11 and 12, the computer 300 comprises a reading device 302, a working memory (RAM) 304, a display 306 which is display means, a mouse 308 and a keyboard 310 which are input means, a communication unit 312 which is communication means, and a CPU 314 for controlling the execution of the content providing program 92, etc. When the recording medium 9 is inserted into the reading device 302, the information recorded in the recording medium 9 becomes accessible from the reading device 302, whereby the content providing program 92 recorded in the program area 91 of the recording medium 9 is executable by the computer 300.

As the reading device 302, a flexible disk drive, a CD-ROM drive, a magnetic tape drive, or the like is used in conformity to the recording medium 9.

The same holds for the content providing program 94 recorded in the recording medium 90.

### INDUSTRIAL APPLICABILITY

In the present invention, as explained in the foregoing, a content package received by content package receiving means is stored into a specific area of content package storing means, content package reading means reads out the content package stored in the specific area, and content providing means provides a user with the content included in thus read-out content package. Hence, if a content package corresponding to a request for providing a content is stored before a user makes the request, for example, the time required for providing the user with the content becomes shorter than in a case where the content is received and provided after the user requests that the content be provided. In response to an instruction signal from a content transmitting system, content package alteration control means erases or alters the content package stored in the specific area, whereby the content package can be updated according to instructions from the content transmitting system. Also, since the content package alteration control means inhibits the user from erasing and altering the content package, the content package can be prevented from being updated in a manner not intended by the content transmitting side.

In another aspect of the present invention, as mentioned above, a content package transmitted by content transmitting system in response to a content transmission request sent by content requesting means is received by content package receiving means, the content package received by the content package receiving means is stored in a specific area of the content package storing means, content package reading means reads out the content package stored in the specific area, and content providing means provides a user with the content included in thus read-out content package. Hence, if a content transmission request is automatically sent beforehand, and a content package corresponding to a request for providing a content is stored before a user makes the request, for example, the time required for providing the user with the content becomes shorter than in a case where the content is received and provided after the user requests that the content be provided. If a content transmission request is sent each time a user inputs the content transmission request, for example, the content package can be received and stored in each instance. In response to an instruction signal from the content transmitting system, content package alteration control means erases or alters the content package stored in the specific area, whereby the content package can be updated according to instructions from the content transmitting system. Also, since the content package alteration control means inhibits the user from erasing and altering the content package, the content package can be prevented from being updated in a manner not intended by the content transmitting side.

If the present invention further comprises content package history transmitting means for transmitting history information of the content package read out by the content package reading means to the content transmitting system, the history information of the content package read out by the content package reading means is transmitted, whereby the content transmitting system can grasp the history of the content supplied to the user.

1. A content providing system comprising:
content package receiving means for receiving a content package, produced by a content transmitting system for transmitting a content to a user, including the content and attribute information concerning an attribute of the content from the content transmitting system;
content package extracting means for extracting according to the attribute information a specific content package from content packages received by the content package receiving means;
content package storing means including a specific area for storing the specific content package extracted by the content package extracting means;
content package alteration control means for erasing or altering a detail of the content package stored in the specific area and inhibiting the user from erasing and altering the detail of the content package stored in the specific area according to an instruction signal transmitted from the content transmitting system;
content package reading means for reading out the content package stored in the specific area; and
content providing means for providing the user with the content included in the content package read out by the content package reading means.

2. A content providing system comprising:
content requesting means for sending a content transmission request to a content transmitting system for producing a content package including a content and transmitting thus produced content package to a user;
content package receiving means for receiving the content package transmitted by the content transmitting system in response to the transmission request sent by the content requesting means;
content package storing means including a specific area for storing the content package received by the package receiving means;
content package alteration control means for erasing or altering a detail of the content package stored in the specific area and inhibiting the user from erasing and altering the detail of the content package stored in the specific area according to an instruction signal transmitted from the content transmitting system;
content package reading means for reading out the content package stored in the specific area; and
content providing means for providing the user with the content included in the content package read out by the content package reading means.

3. A content providing system according to claim 1 or 2, further comprising content package history transmitting means for transmitting history information of the content package read out by the content package reading means to the content transmitting system.

4. A content providing method comprising the steps of:
causing content package receiving means to receive a content package, produced by a content transmitting system for transmitting a content to a user, including the content and attribute information concerning an attribute of the content from the content transmitting system;
causing content package extracting means to extract according to the attribute information a specific content package from content packages received by the content package receiving means and store thus extracted specific content package into a specific area of content package storing means;
causing content package alteration control means to erase or alter a detail of the content package stored in the specific area and inhibit the user from erasing and altering the detail of the content package stored in the specific area according to an instruction signal transmitted from the content transmitting system;
causing content package reading means to read out the content package stored in the specific area; and
causing content providing means to provide the user with the content included in the content package read out by the content package reading means.

5. A content providing method comprising the steps of:
causing content requesting means to send a content transmission request to a content transmitting system for producing a content package including a content and transmitting thus produced content package to a user;
causing content package receiving means to receive the content package transmitted by the content transmitting system in response to the transmission request sent by the content requesting means and store thus received content package into a specific area of content package storing means;
causing content package alteration control means to erase or alter a detail of the content package stored in the specific area and inhibit the user from erasing and altering the detail of the content package stored in the specific area according to an instruction signal transmitted from the content transmitting system;
causing content package reading means to read out the content package stored in the specific area; and
causing content providing means to provide the user with the content included in the content package read out by the content package reading means.

6. A content providing method according to claim 4 or 5, further comprising the step of causing content package history transmitting means to transmit history information of the content package read out by the content package reading means to the content transmitting system.

7. A content providing program for causing a computer to function as:
content package receiving means for receiving a content package, produced by a content transmitting system for transmitting a content to a user, including the content and attribute information concerning an attribute of the content from the content transmitting system;
content package extracting means for extracting according to the attribute information a specific content package from content packages received by the content package receiving means and storing thus extracted specific content package into a specific area of content package storing means;
content package alteration control means for erasing or altering a detail of the content package stored in the specific area and inhibiting the user from erasing and altering the detail of the content package stored in the specific area according to an instruction signal transmitted from the content transmitting system;
content package reading means for reading out the content package stored in the specific area; and
content providing means for providing the user with the content included in the content package read out by the content package reading means.

8. A content providing program for causing a computer to function as:
content requesting means for sending a content transmission request to a content transmitting system for producing a content package including a content and transmitting thus produced content package to a user;
content package receiving means for receiving the content package transmitted by the content transmitting system in response to the transmission request sent by the content requesting means and storing thus received content package into a specific area of content package storing means;
content package alteration control means for erasing or altering a detail of the content package stored in the specific area and inhibiting the user from erasing and altering the detail of the content package stored in the specific area according to an instruction signal transmitted from the content transmitting system;
content package reading means for reading out the content package stored in the specific area; and
content providing means for providing the user with the content included in the content package read out by the content package reading means.

9. A content providing program according to claim 7 or 8, further causing a computer to function as content package history transmitting means for transmitting history information of the content package read out by the content package reading means to the content transmitting system.

10. A computer-readable recording medium recording therein the content providing program according to one of claims 7 to 9.
